(19) United States
(12) Patent Application Publication
(10) Pub. No.: US 2025/0292696 A1
(43) Pub. Date: Sep. 18, 2025

(54) Systems and Devices for Facilitating Productivity Using Mixed Reality

(71) Applicant: Sterile Geeks VR, Inc., Jacksonville, FL (US)

(72) Inventors: Scotty Vincent Jones, Jacksonville, FL (US); Jake McHugh, Saint Augustine, FL (US); Mark Grossnickle, New Haven, CT (US)

(21) Appl. No.: 18/740,461

(22) Filed: Jun. 11, 2024

Related U.S. Application Data
(60) Provisional application No. 63/472,558, filed on Jun. 12, 2023.

(51) Int. Cl. G09B 5/06; G02B 27/01; G06F 3/01; G06F 3/16; G06T 19/00; G09B 19/24

(52) U.S. Cl. CPC G09B 5/06; G02B 27/017; G06F 3/011; G06F 3/167; G06T 19/006; G09B 19/24; G02B 2027/0138

(57) ABSTRACT

The present disclosure provides for systems and devices for facilitating user productivity. The system may comprise at least one mixed reality device. The mixed reality device may comprise wearable technology, such as a headgear or headset that may be worn by a user. Additionally, the mixed reality device may comprise at least one at least partially transparent eye panel configured to superimpose at least one user interface within the user's field of view. The user interface may comprise one or more instructions, directions, educational materials, or other forms of guidance or assistance to help the user perform or execute at least one task. This may assist the user in becoming more efficient or proficient with regard to task completion, or it may enable the user to partake in tasks for which the user has little or no previous experience or training.

### CROSS-REFERENCE TO RELATED APPLICATION

This application claims priority to and the full benefit of U.S. Provisional Patent Application Ser. No. 63/472,558 (filed Jun. 12, 2023, and titled “SYSTEMS AND DEVICES FOR FACILITATING PRODUCTIVITY USING MIXED REALITY”), the entire contents of which are incorporated in this application by reference.

### BACKGROUND

Learning curves are associated with the acquisition of skills and knowledge to complete a myriad of tasks. Individuals routinely seek to take on new hobbies, and almost every industry has several entry level positions that may be filled by novice workers. Particularly in business settings, training new employees can be quite costly, often requiring more advanced professionals to take time away from their other responsibilities to get trainees up to speed. This typically decreases the overall productivity of an enterprise, at least temporarily, while the more senior workers have less time to complete other endeavors.

One environment in which this problem persists is the medical field. For example, hospitals have a variety of entry level positions that may not have prerequisite requirements in the nature formal experience or training, so new employees have to learn new skills as they encounter new situations. This can cause a variety of problems for a hospital, no matter how new workers are set up to be trained.

For instance, sterile processing technicians may be hired with no previous experience or training. One tactic to teach a new technician may be to have a mentor provide assistance during a temporary training period. While this scenario may provide a lot of value to the new hire, the hospital may suffer a loss of productivity while the mentor has less time to perform the regular duties associated with the mentor's job. Alternatively (or additionally), a centralized computer or stationary workstation may be accessed by the novice technician; however, this can make the training process very cumbersome as the technician has to constantly leave the computer to execute tasks, and then return to the computer to confirm the accuracy of task completion. In the worst case scenario, an entry level worker may not receive all of the necessary training and education to successfully perform all required job functions, and so some tasks may be incompletely or improperly executed, which may cause delays in providing patient care or may even jeopardize patient safety.

### SUMMARY OF THE DISCLOSURE

What is needed is are systems and devices for facilitating productivity for a user without requiring in person assistance from others. Systems and devices that facilitate user productivity without disrupting the user's performance of one or more tasks are also desired.

The present disclosure is directed towards systems, devices, and computer program products that facilitate user productivity. In some aspects, a productivity facilitating system is disclosed that comprises a mixed reality device including at least one wearable technology device. In some embodiments, the productivity facilitating system may include a storage medium including at least one datum of task execution instruction data, wherein the at least one storage medium is communicatively coupled to the mixed reality device. In some implementations, the productivity facilitating system may include at least one processor configured to receive the at least one datum of task execution instruction data, interpret the at least one datum of task execution data, present the at least one datum of task execution data to a user via a user interface.

In some embodiments, the productivity facilitating system may include one or more sensors that detect movements of one or more portions of the body and one or more sounds emitted from the user, wherein the one or more sensors are communicatively coupled to the processor to facilitate interactions between the user and the user interface. In some aspects, the interactions between the user and the user interface are displayed by the mixed reality device, wherein the at least one datum of task execution instruction includes one or more typos of training to assist the user with performing one or more tasks.

In some embodiments, the productivity facilitating device may include a visual capture device that may be configured to transmit a portion of an environment within a field of view, wherein the user interface may be communicatively coupled to the visual capture device to incorporate the environment into the at least one datum of task execution instruction data. In some aspects, the at least one datum of task execution instruction data may include the environment captured by the visual capture device, wherein the interactions between the user and the user interface incorporate and adapt to the information received by the visual capture device. In some implementations, the at least one wearable technology device includes a headgear or a headset with at least one partially transparent eye panel, wherein the at least one partially transparent eye panel may be configured to present the user interface within a field of view of the user.

In some embodiments, the at user interface may include one or more two-dimensional or three-dimensional static, moving, or movable images. In some aspects, the data received by the processor from the one or more sensors may be interpreted and converted into one or more instructions that may facilitate one or more interactions between the user and the user interface. In some implementations, the one or more sensors may include a microphone that sends and receives one or more verbal commands from the user to manipulate one or more aspects of the user interface. In some embodiments, the one or more sensors may include one or more motion sensors, wherein the one or more motion sensors detect one or more hand or eye movements to manipulate one or more aspects of the images of the user interface.

In some implementations, the user may be a sterile processing technician, wherein the productivity facilitating system trains the sterile processing technician. In some aspects, the mixed reality device may provide a three-dimensional rendering of a tool that may be manipulated through one or more motions, wherein the one or more motions provide information as to whether the tool may be correct for a predefined operation. In some aspects, the mixed reality device may include instructional videos via the user interface for a variety of role-specific tasks.

In some embodiments, the productivity facilitating system may include a plurality of users. In some aspects, a first user may interact with a second user, wherein the first user may transmit at least a portion of the environment within the field of view of the mixed reality device of the first user to the mixed reality device of the second user such that the second user views and interacts with the user interface of the first user. In some implementations, the first user with a mixed reality device may interact with a second user, wherein the second user utilizes a computing device to view one or more images captured by the mixed reality device of the first user.

In some implementations, the present disclosure may disclose a method for productivity facilitating. In some embodiments, the method may include displaying a user interface on a mixed reality device, sending at least one datum to the user, sensing movement and audio of a user interacting with the mixed reality device, and capturing the environment of the user through a video capture device. In some aspects, the at least one datum of task execution instruction may include one or more types of training. In some implementations, the sensed movement and audio of the user as well as the rendering of the captured environment is manipulated by one or more aspects of the user interface.

### BRIEF DESCRIPTION OF THE DRAWINGS

The accompanying drawings that are incorporated in and constitute a part of this specification illustrate several embodiments of the disclosure and, together with the description, serve to explain the principles of the disclosure:

FIG. 1A illustrates an exemplary productivity facilitating system, according to some embodiments of the present disclosure.

FIG. 1B illustrates an exemplary mixed reality device configured for use with a productivity facilitating system, according to some embodiments of the present disclosure.

FIG. 1C illustrates an exemplary mixed reality device configured for use with a productivity facilitating system, according to some embodiments of the present disclosure.

FIG. 2A illustrates an exemplary productivity facilitating system, according to some embodiments of the present disclosure.

FIG. 2B illustrates an exemplary productivity facilitating system, according to some embodiments of the present disclosure.

FIG. 3A illustrates an exemplary productivity facilitating system, according to some embodiments of the present disclosure.

FIG. 3B illustrates an exemplary productivity facilitating system, according to some embodiments of the present disclosure.

FIG. 4A illustrates an exemplary user interface presented by a mixed reality device of a productivity facilitating system, according to some embodiments of the present disclosure.

FIG. 4B illustrates an exemplary user interface presented by a mixed reality device of a productivity facilitating system, according to some embodiments of the present disclosure.

FIG. 5A illustrates an exemplary user interface presented by a mixed reality device of a productivity facilitating system, according to some embodiments of the present disclosure.

FIG. 5B illustrates an exemplary user interface presented by a mixed reality device of a productivity facilitating system, according to some embodiments of the present disclosure.

FIG. 6A illustrates an exemplary user interface presented by a mixed reality device of a productivity facilitating system, according to some embodiments of the present disclosure.

FIG. 6B illustrates an exemplary user interface presented by a mixed reality device of a productivity facilitating system, according to some embodiments of the present disclosure.

FIG. 7 illustrates an exemplary user interface presented by a mixed reality device of a productivity facilitating system, according to some embodiments of the present disclosure.

FIG. 8 illustrates an exemplary user interface presented by a mixed reality device of a productivity facilitating system, according to some embodiments of the present disclosure.

FIG. 9A illustrates an exemplary user interface presented by a mixed reality device of a productivity facilitating system, according to some embodiments of the present disclosure.

FIG. 9B illustrates an exemplary user interface presented by a mixed reality device of a productivity facilitating system, according to some embodiments of the present disclosure.

FIG. 10 illustrates an exemplary user interface presented by a mixed reality device of a productivity facilitating system, according to some embodiments of the present disclosure.

The Figures are not necessarily drawn to scale, as their dimensions can be varied considerably without departing from the scope of the present disclosure.

### DETAILED DESCRIPTION

The present disclosure provides generally for systems, devices, and computer program products for facilitating user productivity using mixed reality. According to the present disclosure, a productivity facilitating system may comprise at least one mixed reality device. In some aspects, the mixed reality device may at least partially comprise at least one wearable technology device. In some implementations, the productivity facilitating system may comprise at least one storage medium that comprises at least one datum of task execution instruction that may be presented to a user via a user interface displayed via an at least partially transparent eye panel of the mixed reality device such that one or more task execution instructions may be superimposed within the user's field of view. In some aspects, this may allow the user to receive guidance for completing at least one task without disrupting the user's performance of the task.

In the following sections, detailed descriptions of examples and methods of the disclosure will be given. The descriptions of both preferred and alternative examples, though thorough, are exemplary only, and it is understood to those skilled in the art that variations, modifications, and alterations may be apparent. It is therefore to be understood that the examples do not limit the broadness of the aspects of the underlying disclosure as defined by the claims.

### Glossary

Mixed reality device: as user herein refers to any device or apparatus that provides an augmented reality or mixed reality experience for a user. In some aspects, a mixed reality device may at least partially comprise a wearable technology device. In some non-limiting exemplary embodiments, a mixed reality device may comprise a headgear or headset that comprises at least one at least partially transparent eye panel, wherein the eye panel may be configured to present at least one user interface that comprises one or more two-dimensional or three-dimensional images that may be superimposed within thin a user's field of view.
Task execution instruction: as used herein refers to any data that may comprise guidance or education to a user for completing at least one task. In some aspects, one or more task execution instructions may be presented to a user via a user interface associated with a mixed reality device. In some non-limiting exemplary embodiments, task execution instructions may comprise guidance for performing one or more medical, mechanical, repair, or cooking tasks, or one or more types of educational content to teach a user how to better perform one or more tasks.

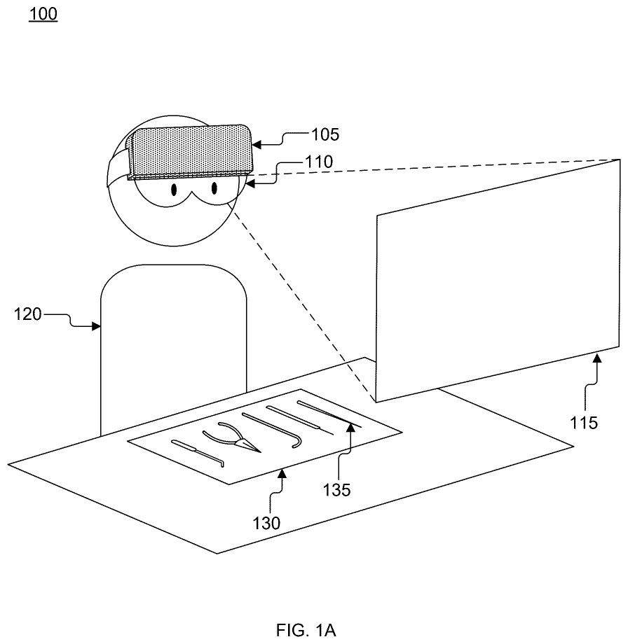

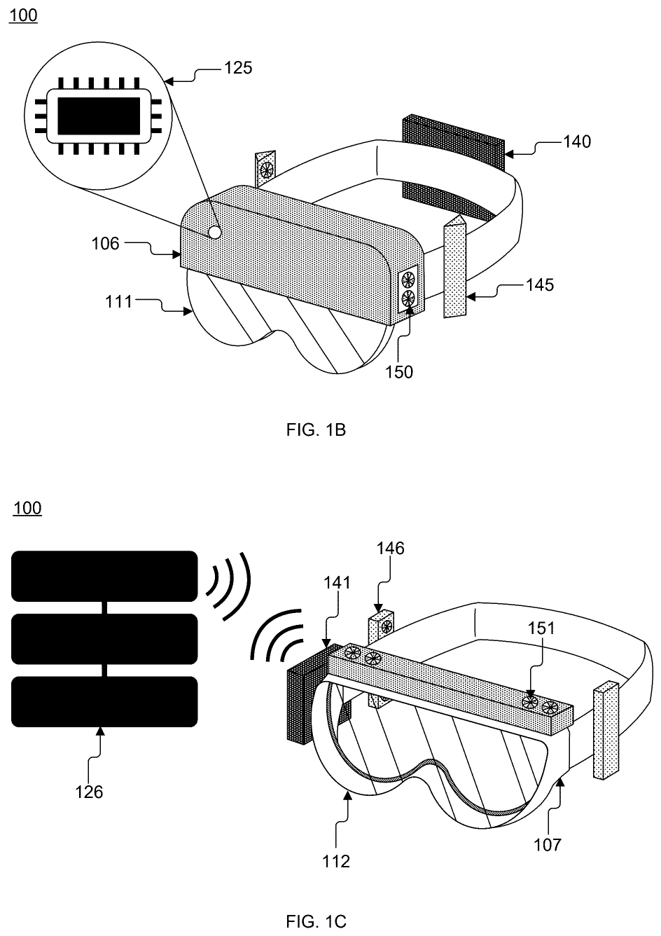

Referring now to FIGS. 1A-1C, an exemplary productivity facilitating system 100 and exemplary mixed reality device 105, 106, 107 configured for use therewith, according to some embodiments of the present disclosure, are illustrated. In some aspects, the productivity facilitating system 100 may comprise at least one mixed reality device 105, 106, 107. In some implementations, the mixed reality device 105, 106, 107 may at least partially comprise at least one wearable technology device. In some non-limiting exemplary embodiments, the mixed reality device 105, 106, 107 may comprise a headgear or headset that comprises at least one at least partially transparent eye panel 110, 111, 112. By way of example and not limitation, the eye panel 110, 111, 112 may comprise one or more at least partially transparent materials, such as glass, plastic, or other polymers, as non-limiting examples, as well as any combination thereof. In some implementations, the eye panel 110, 111, 112 may be configured to present at least one user interface 115 within the field of view of a user 120 of the mixed reality device 105, 106, 107.

In some aspects, the productivity facilitating system 100 may comprise at least one storage medium 125, 126. In some implementations, the storage medium 125 may be configured internally within at least one portion of the mixed reality device 106, or the storage medium 126 may be configured externally or remotely from the mixed reality device 107, wherein the storage medium 126 may be communicatively coupled to the mixed reality device 107 by at least one network connection, such as a connection to the global, public Internet or a connection to a local area network (LAN), as non-limiting examples.

In some embodiments, the storage medium 125, 126 may comprise at least one datum of task execution instruction data. In some aspects, the mixed reality device 105, 106, 107 may comprise at least one processor configured to receive the task execution instruction data, interpret the task execution instruction data, and present the task execution instruction data to the user 120 via the user interface 115. In some implementations, the task execution instruction data may comprise one or more software instructions or other coded algorithms that may be interpreted by the processor of the mixed reality device 105, 106, 107, wherein execution of the coded algorithms by the processor may cause the mixed reality device 105, 106, 107 to generate and present the user interface 115.

In some aspects, the user interface 115 may comprise one or more two-dimensional or three-dimensional static, moving, or movable images that may be presented to the user 120 via the eye panel 110, 111, 112. In some implementations, the mixed reality device 105, 106, 107 may enable the user 120 to interact with the images of the user interface 115. In some non-limiting exemplary embodiments, the mixed reality device 105, 106, 107 may comprise one or more sensors that may sense or detect one or more movements of one or more portions of the body of the user 120 or one or more words or other sounds emitted from the user 120, wherein the sensors may be communicatively coupled to the processor of the mixed reality device 105, 106, 107 such that data obtained by the sensors may be transmitted to the processor, wherein the processor may be configured to interpret the sensor data and convert the data to one or more instructions that facilitate one or more interactions between the user 120 and the user interface 115. By way of example and not limitation, the mixed reality device 105, 106, 107 may comprise one or more motion sensors that detect one or more hand or eye movements of the user 120 such that the hand or eye movements may manipulate one or more aspects of the images of the user interface 115. By way of further example and not limitation, the mixed reality device 105, 106, 107 may comprise one or more audio sensors in the form of a microphone that may receive one or more verbal commands from the user 120 to manipulate one or more aspects of the user interface 115.

As a non-limiting illustrative example, the user 120 may be a sterile processing technician assigned to work in an operating room at a hospital. During the preparation of a surgical tray 130, the user 120 may be unsure of the appearance of one or more tools 135 needed for the tray 130, and so the user 120 may use the mixed reality device 105 to view a three-dimensional rendering of the tool 135, wherein the user 120 may manipulate the rendered image of the tool 135 using various hand movements or gestures. By rotating or otherwise altering the view of the image of the tool 135, the user 120 may gain a thorough understanding of the appearance of the tool 135, which may increase the likelihood that the user 120 will retrieve the correct tool 135 for placement within the tray 130.

As an additional non-limiting illustrative example, the user 120 may comprise a sterile processing technician assembling a surgical tray 130, and the technician may desire to watch an instructional video explaining how to assemble the surgical tray 130 via the user interface 115 of the mixed reality device 105, 106, 107. Because the user 120 may not have a free hand to manipulate images presented via the user interface 115, the user 120 may state a command, such as, for example and not limitation, “Play training video 100 for surgical tray assembly,” which may prompt the processor of the mixed reality device 105, 106, 107 to begin playback of the requested video, wherein the video may be stored in a data file within the storage medium 125, 126.

In some implementations, the mixed reality device 105, 106, 107 may comprise one or more various features or components. By way of example and not limitation, the mixed reality device 105, 106, 107 may comprise one or more of: at least one power source 140, 141, at least one cooling fan 145, 146, or at least one audio emitting device 150, 151, such as a speaker. In some non-limiting exemplary embodiments, the power source 140, 141 may comprise a battery, which, in some aspects, may be rechargeable and/or replaceable. In some implementations, the cooling fans 145, 146 may be configured to facilitate airflow towards at least a portion of the face of the user 120 to provide a cooling effect, or the cooling fans 145, 146 may be configured to facilitate airflow away from the user 120 to dissipate heat away from the user 120.

In some aspects, the mixed reality device 105, 106, 107 may comprise one or more features that make it well suited for use in sterile or contaminated environments. By way of example and not limitation, the exterior surface of the mixed reality device 105, 106, 107 may comprise one or more portions configured such that the internal electronic components of the mixed reality device 105, 106, 107 are sealed and protected from liquids, which may allow for one or more sterilizing or other cleaning agents to be applied to the mixed reality device 105, 106, 107 without causing damage. By way of further example and not limitation, the mixed reality device may be configured to removably receive a disposable visor plate or similar structure that may be interchanged between uses.

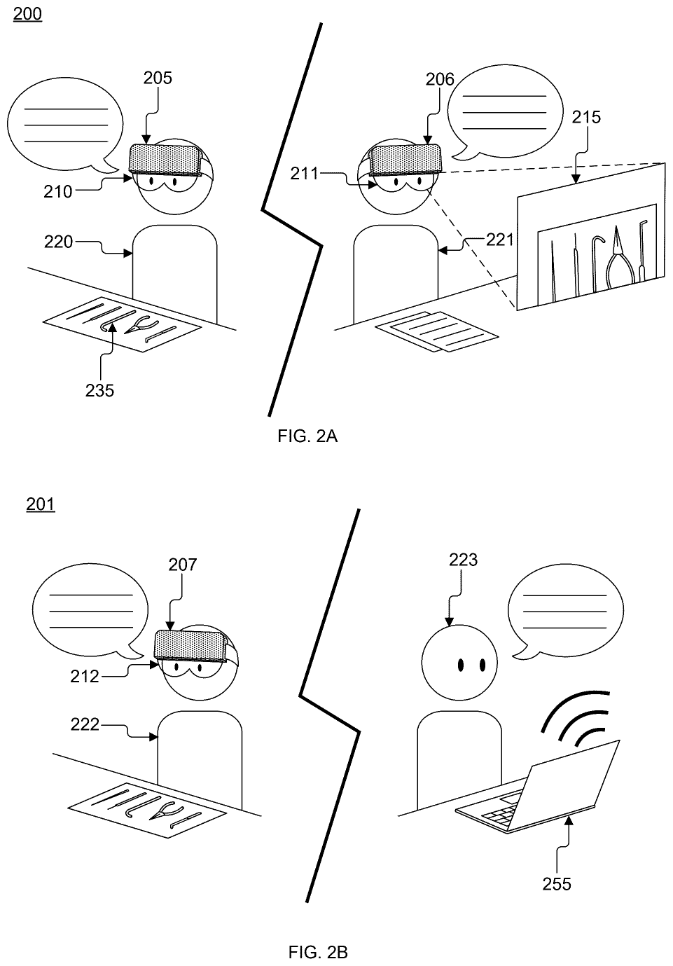

Referring now to FIGS. 2A-2B, exemplary productivity facilitating systems 200, 201, according to some embodiments of the present disclosure, are illustrated. In some aspects, the productivity facilitating system 200, 201 may comprise a plurality of mixed reality devices 205, 206, 207. In some implementations, each mixed reality device 205, 206, 207 may at least partially comprise a wearable technology device such that the plurality of mixed reality devices 205, 206, 207 may be worn by a plurality of users 220, 221, 222. In some non-limiting exemplary embodiments, each of the mixed reality devices 205, 206, 207 may comprise a headgear or headset that comprises at least one at least partially transparent eye panel 210, 211, 212 configured to present at least one user interface superimposed within the field of view of the user 220, 221, 222.

In some aspects, each mixed reality device 205, 206, 207 may comprise at least one audio input device and at least one audio emitting device to facilitate communication between two or more users 220, 221, 222, 223. By way of example and not limitation, the audio input device may comprise a microphone and the audio emitting device may comprise a speaker.

In some implementations, the productivity facilitating system 200 may comprise a plurality of users 220, 221, wherein each user 220, 221 may utilize a mixed reality device 205, 206. In some aspects, a first user 220 may require assistance from a second user 221, wherein the second user 221 may be located remotely from the first user 220, such as by being in another room, department, building, or country. In some embodiments, the mixed reality device 205, 206 of each user 220, 221 may comprise at least one processor configured to interpret and execute one or more coded software instructions or algorithms that enable the mixed reality device 205 of the first user 220 to transmit at least a portion of the environment within the field of view of the first user 220 to the mixed reality device 206 of the second user 221 such that the second user 221 may be able to view a user interface 215 comprising one or more two-dimensional or three-dimensional renderings of what is within the range of one or more visual capture components integrated with or communicatively coupled to the mixed reality device 205, 206. By way of example and not limitation, a visual capture component may comprise one or more cameras. In some non-limiting exemplary embodiments, at least a portion of the eye panel 210, 211 of the mixed reality device 205, 206 may comprise a lens that may function as a visual capture component.

As a non-limiting illustrative example, the first user 220 may comprise a sterile processing technician preparing one or more tools 235 for a surgical tray or case cart. The first user 220 may be unsure of how to properly inspect or sterilize one of the tools, and so the first user 220 may use the mixed reality device 205 to contact the second user 221, who may be a technician with more experience or training. The second user 221 may be able to view the tool 235 in question via the user interface of the mixed reality device 206 to see exactly what the first user 220 sees in real time without having to physically move to be proximate to the first user 220. This may allow the second user 221 to give instructions or guidance to the first user 220 while providing a minimal amount of disruption to the productivity of the second user 221.

In some non-limiting exemplary implementations, a first user 222 may be able to use a mixed reality device 207 to communicate with and seek guidance from a second user 223, even if the second user 223 does not utilize a mixed reality device 205, 206, 207. In such aspects, the second user 223 may be able to utilize a computing device 255, such as, by way of example and not limitation, a desktop computer, a laptop computer, a tablet, or a smartphone, to view one or more images or renderings captured by the mixed reality device 207 of the first user 222.

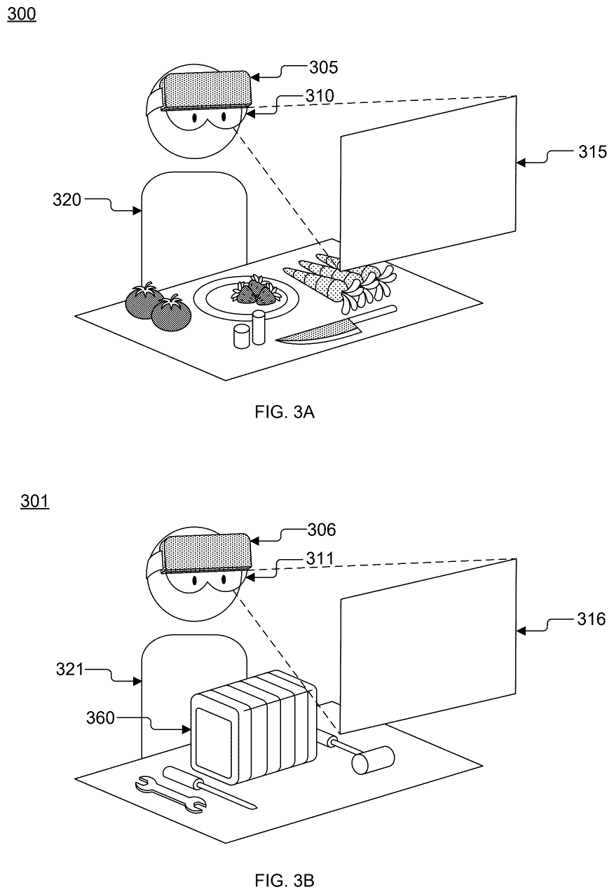

Referring now to FIGS. 3A-3B, exemplary productivity facilitating systems 300, 301, according to some embodiments of the present disclosure, are illustrated. In some aspects, the productivity facilitating system 300, 301 may comprise at least one mixed reality device 305, 306. In some implementations, the mixed reality device 305, 306 may at least partially comprise at least one wearable technology device. In some non-limiting exemplary embodiments, the mixed reality device 305, 306 may comprise a headgear or headset that comprises at least one at least partially transparent eye panel 310, 311. By way of example and not limitation, the eye panel 310, 311 may comprise one or more at least partially transparent materials, such as glass, plastic, or other polymers, as non-limiting examples, as well as any combination thereof. In some implementations, the eye panel 310, 311 may be configured to present at least one user interface 315, 316 within the field of view of a user 320, 321 of the mixed reality device 305, 306.

In some aspects, the mixed reality device 305, 306 may be configured for one or more of a variety of potential uses or applications. In some implementations, by allowing a user 320, 321 to view one or more instructional or informational images, renderings, steps, videos, or descriptions of how to execute at least one task via the user interface 315, 316, as well as hear any audio content associated therewith via one or more speakers, the mixed reality device 305, 306 may enable the user 320, 321 to complete tasks in a more proficient or efficient manner.

As a non-limiting illustrative example, a user 320 may use a mixed reality device 305 to obtain assistance with preparing a meal. The mixed reality device 305 may present a user interface 315 within the field of view of the user 320 that comprises one or more images, videos, recipes, or similar content superimposed in front of the user 320 such that the user 320 may be able to follow along with the guidance in real time while performing the necessary tasks to execute the meal preparation. In some implementations, the user 320 may be able to use the mixed reality device 305 to communicate with and obtain assistance from one or more remotely located individuals who may be more experienced or skilled in meal preparation, such as a relative, friend, or culinary instructor, as non-limiting examples.

As an additional non-limiting illustrative example, a user 321 may use a mixed reality device 306 to obtain assistance in constructing an object 360. The mixed reality device 306 may present a user interface 316 within the field of view of the user 321 that comprises one or more images, videos, instructional manuals, or similar content superimposed in front of the user 321 such that the user 321 may be able to follow along with the guidance in real time while performing the necessary tasks successfully assemble the object 360. In some implementations, the user 321 may be able to use the mixed reality device 306 to communicate with and obtain assistance from one or more remotely located individuals who may be more experienced or skilled in construction or mechanics, such as a relative, friend, or expert consultant, as non-limiting examples.

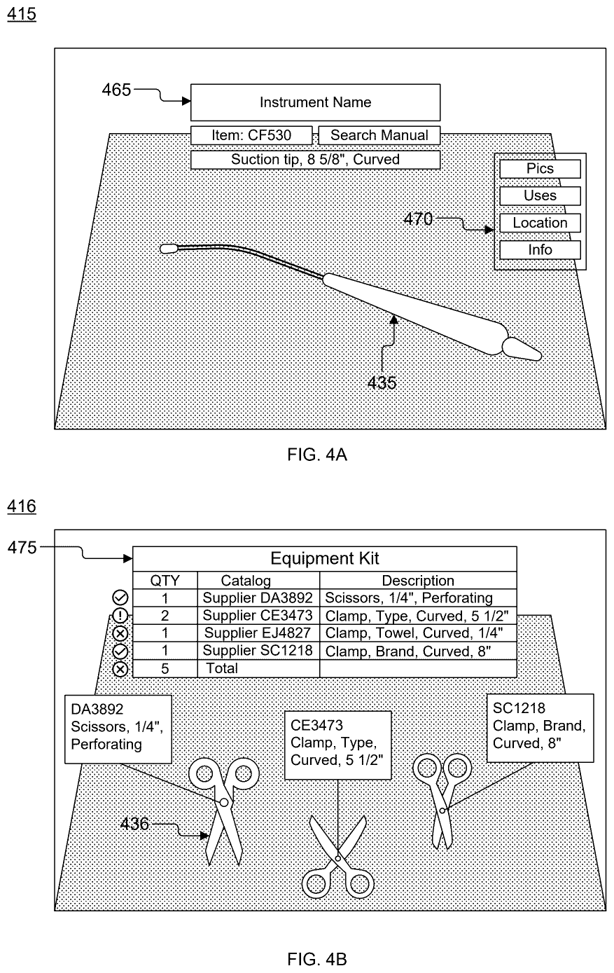

Referring now to FIGS. 4A-4B, exemplary user interfaces 415, 416 presented by a mixed reality device of a productivity facilitating system, according to some embodiments of the present disclosure, are illustrated. In some aspects, the user interface 415, 416 may be presented to a user of a mixed reality device via at least one eye panel integrated with the mixed reality device, wherein the eye panel may be configured to superimpose one or more two-dimensional or three-dimensional images, renderings, or videos with the field of view of the user.

In some non-limiting exemplary embodiments, the user interface 415, 416 may be presented to a user that comprises a sterile processing technician at a hospital. In some aspects, the technician may use a mixed reality device while inspecting or cleaning at least one tool 435 to be implemented with a surgical tray or case cart, as non-limiting examples. In some implementations, one or more visual capture devices integrated with or communicatively coupled to the mixed reality device may capture an image of the tool, and one or more software instructions or similar coded instructions may enable one or more processors within the mixed reality device to identify the tool 435, wherein identification of the tool 435 may be facilitated by image recognition or by identifying or scanning a serial number or barcode on the tool 435, as non-limiting examples. In some embodiments, this may cause the mixed reality device to generate and present one or more identifiers 465 for the tool 435 within the user interface 415 that may enable the user to accurately confirm the identity of the tool 435 to ensure that the right tool 435 is being selected. By way of example and not limitation, identifiers 465 may comprise the name of the tool 435, a description of the tool 435, or an identification number or serial number of the tool 435, as non-limiting examples.

In some aspects, the mixed reality device may also be configured to generate and present one or more options 470 to the user via the user interface 415 that may allow the user to obtain more information about the tool 435. By way of example and not limitation, options 470 may comprise a link to pictures, renderings, or videos of the tool 435; a link to one or more descriptions of intended uses of the tool 435; a link to where the tool 435 is located in inventory; or a link to more information about the tool 435.

In some implementations, a sterile processing technician using a mixed reality device may be presented with a user interface 416. In some non-limiting exemplary embodiments, the mixed reality device may be configured to visually capture images of a plurality of tools 436, identify each of the tools 436, generate and present one or more identifiers for each tool 436, generate and present a list 475 of tools 436 required for a surgical tray or case cart, and correlate the identified tools 436 with the list 475 to help the user determine if the tools 436 in front of the user are correct for the list 475, or whether any tools 436 need to be added, changed, or removed to satisfy the requirements of the list 475.

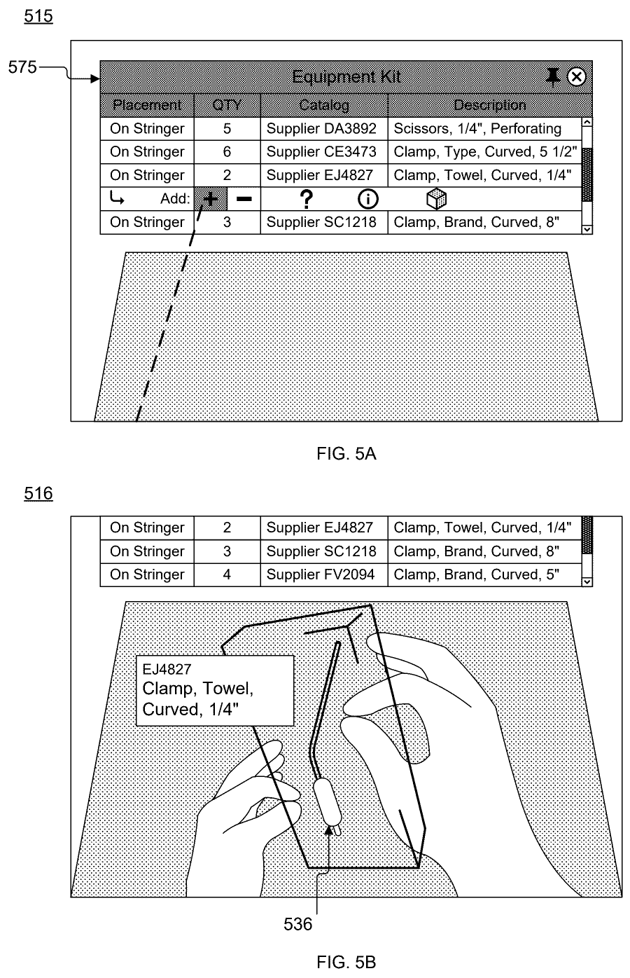

Referring now to FIGS. 5A-5B, exemplary user interfaces 515, 516 presented by a mixed reality device of a productivity facilitating system, according to some embodiments of the present disclosure, are illustrated. In some aspects, the user interface 515, 516 may be presented to a user of a mixed reality device via at least one eye panel integrated with the mixed reality device, wherein the eye panel may be configured to superimpose one or more two-dimensional or three-dimensional images, renderings, or videos with the field of view of the user.

Some non-limiting exemplary embodiments, the user interface 515, 516 may be presented to a user that comprises a sterile processing technician at a hospital. In some aspects, the technician may use a mixed reality device while preparing a surgical tray or case cart, as non-limiting examples.

In some non-limiting exemplary implementations, the user interface 515 may comprise a list 575 of one or more tools or devices that may be required for a surgical tray or case cart, wherein the list 575 may be generated and presented by a mixed reality device. In some aspects, the mixed reality device may comprise one or more software instructions or other coded algorithms that may be interpreted and executed by one or more processors to allow a user of the mixed reality device to interact with the list 575. By way of example and not limitation, the mixed reality device may comprise one or more sensors configured to sense or detect one or more hand or eye movements of the user, or one or more words or other sounds emitted from the user, wherein the detected movements or sounds may cause the list 575 to be manipulated in at least one aspect. As a non-limiting illustrative example, the user may be able to add items to, remove items from, or otherwise modify the list 575 using one or more eye movements.

In some non-limiting exemplary embodiments, the user interface 516 may comprise at least one three-dimensional rendering of at least one tool 536 that may be viewed and manipulated by a user so that the user may better understand what the tool 536 looks like. In some aspects, the user may be able to rotate the rendering of the tool 536 or adjust the size of the rendering using one or more hand movements that may be captured by one or more sensors of the mixed reality device, as nom-limiting examples.

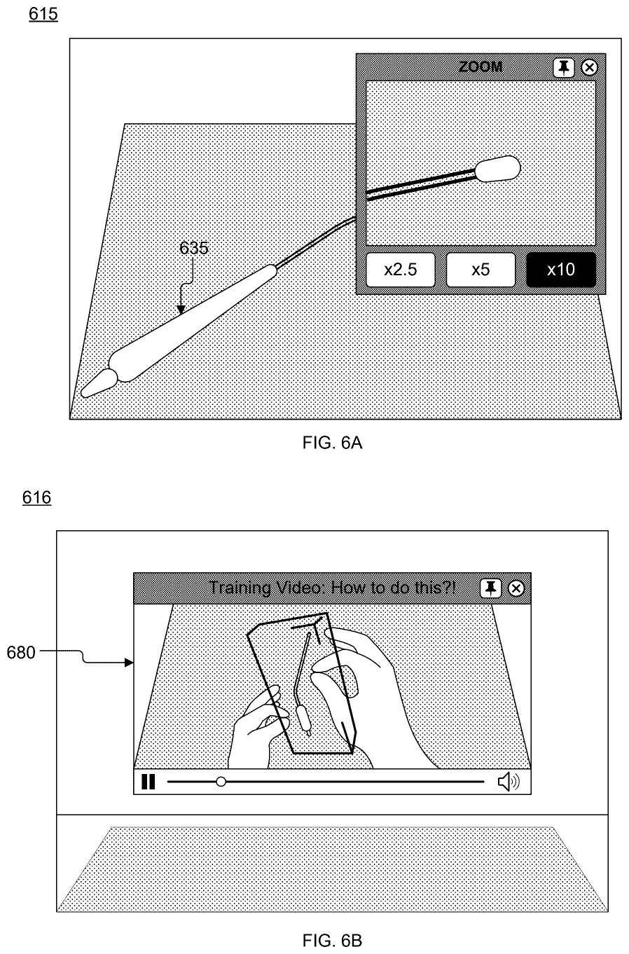

Referring now to FIGS. 6A-6B, exemplary user interfaces 615, 616 presented by a mixed reality device of a productivity facilitating system, according to some embodiments of the present disclosure, are illustrated. In some aspects, the user interface 615, 616 may be presented to a user of a mixed reality device via at least one eye panel integrated with the mixed reality device, wherein the eye panel may be configured to superimpose one or more two-dimensional or three-dimensional images, renderings, or videos with the field of view of the user.

In some non-limiting exemplary embodiments, the user interface 615, 616 may be presented to a user that comprises a sterile processing technician at a hospital. In some aspects, the technician may use a mixed reality device while assembling or preparing a surgical tray or case cart, as non-limiting examples.

In some non-limiting exemplary implementations, the user interface 615 be generated and presented by a mixed reality device. In some aspects, the mixed reality device may comprise one or more software instructions or other coded algorithms that may be interpreted and executed by one or more processors to access at least one magnification lens integrated with or communicatively coupled to the mixed reality device, capture a magnified image of at least a portion of one or more objects or items within the field of view of the magnification lens, and present the magnified image or a generated rendering of the magnified image via the user interface 615. By way of example and not limitation, the magnification lens may comprise at least one portion of the eye panel of the mixed reality device.

As a non-limiting illustrative example, a user comprising a sterile processing technician may use a mixed reality device with a magnification lens to view one or more tools 635, wherein a magnified view of the tool 635 may be generated presented to the user via the user interface 615 to enable the user to view one or more aspects or details of the tool 635 more clearly. This may help the user ensure that an accurate tool 635 is selected for a surgical tray or case cart, as non-limiting examples.

In some aspects, the user interface 616 comprising educational content may be generated and presented to a user of a mixed reality device to allow the user to learn how to perform or execute one or more tasks. As a non-limiting illustrative example, the user interface 616 may comprise one or more training videos 680 that may be viewed by a user. By way of example and not limitation, a user may maximize productivity during the course of a workday by viewing at least a portion of a training video 680 during a break or between other tasks.

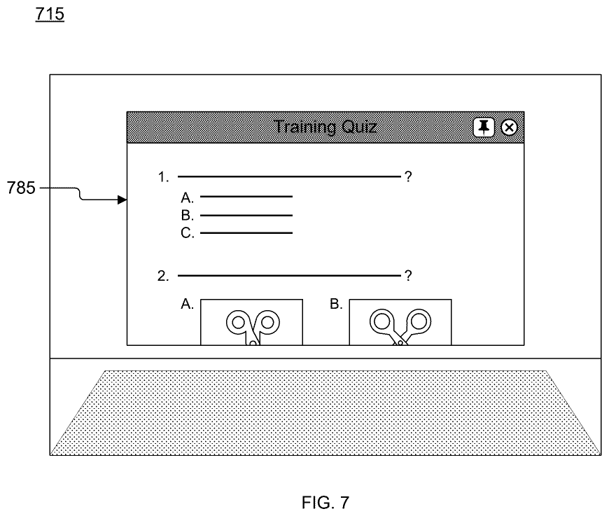

Referring now FIG. 7, an exemplary user interface 715 presented by a mixed reality device of a productivity facilitating system, according to some embodiments of the present disclosure, is illustrated. In some aspects, the user interface 715 may be presented to a user of a mixed reality device via at least one eye panel integrated with the mixed reality device, wherein the eye panel may be configured to superimpose one or more two-dimensional or three-dimensional images, renderings, or videos with the field of view of the user.

In some non-limiting exemplary implementations, the user interface 715 may be generated and presented by a mixed reality device. In some aspects, the mixed reality device may comprise one or more software instructions or other coded algorithms that may be interpreted and executed by one or more processors to generate and/or present a user interface 715 comprising educational content to a user. By way of example and not limitation, the user interface 715 may comprise one or more quizzes or tests 785 that may be completed by a user to verify the user's proficiency regarding one or more topics. In some implementations, a user may complete a test 785 to obtain one or more licenses, certifications, or education credits, as non-limiting examples. In some aspects, by utilizing a mixed reality device to complete a test 785, a user may be able to obtain one or more continuing education credits during a break or between other tasks, as a non-limiting example.

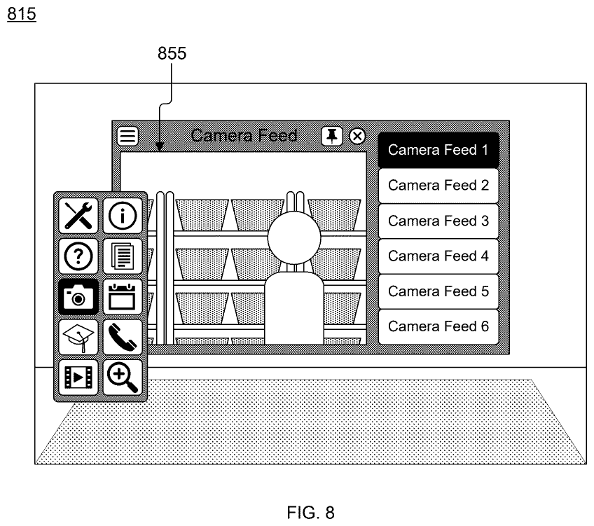

Referring now to FIG. 8, exemplary user interface 815 presented by a mixed reality device of a productivity facilitating system, according to some embodiments of the present disclosure, is illustrated. In some aspects, the user interface 815 may be presented to a user of a mixed reality device via at least one eye panel integrated with the mixed reality device, wherein the eye panel may be configured to superimpose one or more two-dimensional or three-dimensional images, renderings, or videos with the field of view of the user.

In some non-limiting exemplary implementations, the user interface 815 may be generated and presented by a mixed reality device that is communicatively coupled to one or more remotely located visual capture devices, such as one or more cameras. In some aspects, the mixed reality device may comprise one or more software instructions or other coded algorithms that may be interpreted and executed by one or more processors to generate and/or present a user interface 815 that comprises one or more static or moving images received from one or more remote cameras. In some implementations, the images may be received in substantially real time, or the images may be previously recorded and received from one or more databases or other storage media, as non-limiting examples.

As a non-limiting illustrative example, a user comprising a sterile processing technician may use a mixed reality device to assemble or prepare a surgical tray or case cart. The technician may determine that one or more tools or devices may be needed from an inventory room, and before taking the time to physically travel to the inventory room, the technician may use the mixed reality device to view the user interface 815 that comprises a live camera feed 855 from the relevant portion of the interior of the inventory room to ascertain whether the required tools, devices, or other supplies are currently available.

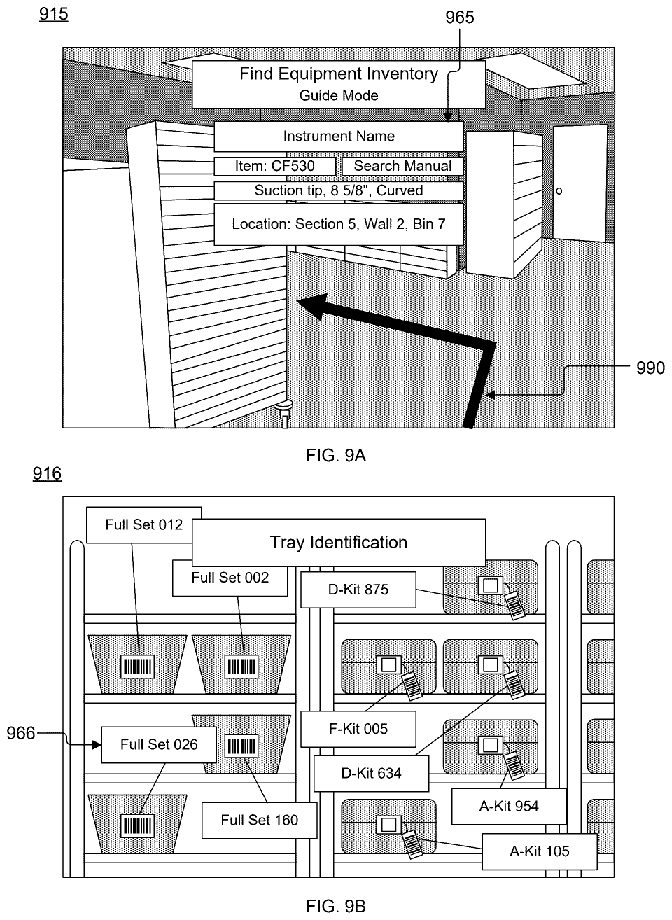

Referring now to FIGS. 9A-9B, exemplary user interfaces 915, 916 presented by a mixed reality device of a productivity facilitating system, according to some embodiments of the present disclosure, are illustrated. In some aspects, the user interface 915, 916 may be presented to a user of a mixed reality device via at least one eye panel integrated with the mixed reality device, wherein the eye panel may be configured to superimpose one or more two-dimensional or three-dimensional images, renderings, or videos with the field of view of the user.

In some non-limiting exemplary embodiments, the user interface 915, 916 may be presented to a user that comprises a sterile processing technician at a hospital. In some aspects, the technician may use a mixed reality device while assembling or preparing a surgical tray or case cart, as non-limiting examples.

In some non-limiting exemplary implementations, the user interface 915, 916 may be generated and presented by a mixed reality device. In some aspects, the mixed reality device may comprise one or more software instructions or other coded algorithms that may be interpreted and executed by one or more processors to generate and/or present a user interface 915, 916 that comprises one or more inventory management features.

In some aspects, the user interface 915 may comprise one or more instructions, directions, or other forms of guidance for navigating an inventory room, department, or building. In some implementations, the guidance may comprise one or more types of word-based content or one or more visual indicators or representations. By way of example and not limitation, the user interface 915 may present one or more identifiers 965 to the user of the mixed reality device, such as a name, identification number, and description of a tool, device, or instrument being sought, as well as location information identifying where the tool is located in the inventory room. Additionally, by way of further example and not limitation, the user interface 915 may comprise one or more visual indicators 990 that may direct or guide the user through the inventory room along the most efficient route.

In some non-limiting exemplary embodiments, the mixed reality device may be configured to locate and interpret one or more labels or markings within an inventory environment and generate and present one or more corresponding identifiers 966 to the user of the mixed reality device via the user interface 916. In some aspects, this may help the user locate one or more desired tools, devices, instruments, or other supplies in a more expeditious manner by not having to visually inspect each label to find the right one. In some non-limiting exemplary implementations, the mixed reality device may be configured to identify, capture, and scan a barcode, QR code, or similar visual element associated with one or more items in inventory and communicate with an inventory management system to track which items have been removed from or returned to the inventory room, as well as the identity of the user who removed or returned the relevant item(s), as non-limiting examples.

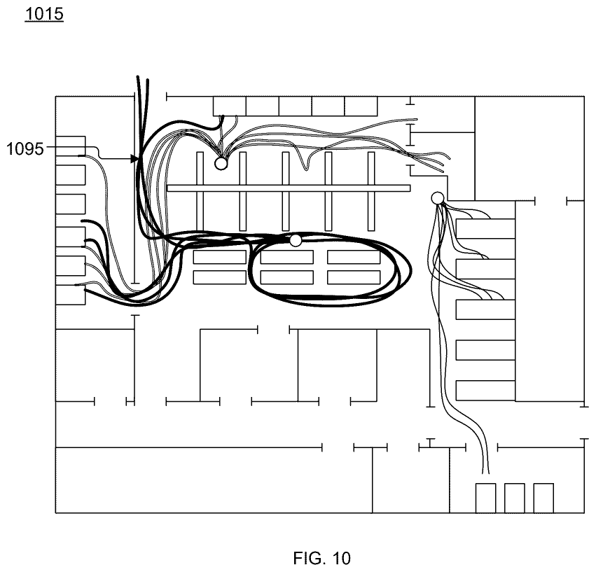

Referring now to FIG. 10, an exemplary user interface 1015 presented by a mixed reality device of a productivity facilitating system, according to some embodiments of the present disclosure, is illustrated. In some aspects, the user interface 1015 may be presented to a user of a mixed reality device via at least one eye panel integrated with the mixed reality device, wherein the eye panel may be configured to superimpose one or more two-dimensional or three-dimensional images, renderings, or videos with the field of view of the user, or the user interface 1015 may be presented to a user via at least one display screen integrated with or communicatively coupled to a computing device, such as a desktop computer, a laptop computer, a tablet, or a smartphone, as non-limiting examples.

In some implementations, the user interface 1015 may comprise a visual representation of at least one room, department, building, or facility, as non-limiting examples. In some aspects, the user interface may comprise one or more routes 1095 traversed by one or more users of mixed reality devices within a productivity facilitating system. In some embodiments, each mixed reality device may comprise one or more location tracking components that are communicatively coupled to at least one database or other storage medium such that the movements of the mixed reality device (and the user associated therewith) may be monitored and tracked. In some implementations, this may allow the productivity facilitating system to identify when users are utilizing inefficient routes 1095 to complete tasks such that suggestions may be made to the users on how to be more efficient, or one or more potential improvements may be identified for the relevant area to make navigation easier.

As a non-limiting illustrative example, a plurality of users comprising sterile processing technicians or other hospital employees may each utilize a mixed reality device with location tracking capabilities. The routes 1095 that the users take within an inventory room may be tracked and monitored to identify which users may be having trouble navigating the room to find needed tools or supplies. If a significant number of users have difficulty navigating the room in an efficient manner, then the hospital administrators or other authorities may consider reconfiguring the layout of the inventory room to make it more intuitive.

### Conclusion

A number of embodiments of the present disclosure have been described. While this specification contains many specific implementation details, these should not be construed as limitations on the scope of any disclosures or of what may be claimed, but rather as descriptions of features specific to particular embodiments of the present disclosure.

Certain features that are described in this specification in the context of separate embodiments can also be implemented in combination or in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

Moreover, the separation of various system components in the embodiments described above should not be understood as requiring such separation in all embodiments, and it should be understood that the described components and systems can generally be integrated together in a single product or packaged into multiple products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order show, or sequential order, to achieve desirable results. In certain implementations, multitasking and parallel processing may be advantageous. Nevertheless, it will be understood that various modifications may be made without departing from the spirit and scope of the claimed disclosure.

Reference in this specification to “one embodiment,” “an embodiment,” any other phrase mentioning the word “embodiment”, “aspect”, or “implementation” means that a particular feature, structure, or characteristic described in connection with the embodiment is included in at least one embodiment of the disclosure and also means that any particular feature, structure, or characteristic described in connection with one embodiment can be included in any embodiment or can be omitted or excluded from any embodiment. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others and may be omitted from any embodiment. Furthermore, any particular feature, structure, or characteristic described herein may be optional.

Similarly, various requirements are described which may be requirements for some embodiments but not other embodiments. Where appropriate any of the features discussed herein in relation to one aspect or embodiment of the invention may be applied to another aspect or embodiment of the invention. Similarly, where appropriate any of the features discussed herein in relation to one aspect or embodiment of the invention may be optional with respect to and/or omitted from that aspect or embodiment of the invention or any other aspect or embodiment of the invention discussed or disclosed herein.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks: The use of highlighting has no influence on the scope and meaning of a term; the scope and meaning of a term is the same, in the same context, whether or not it is highlighted.

It will be appreciated that the same thing can be said in more than one way. Consequently, alternative language and synonyms may be used for any one or more of the terms discussed herein. No special significance is to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

It will be appreciated that terms such as “front,” “back,” “top,” “bottom,” “side,” “short,” “long,” “up,” “down,” “aft,” “forward,” “inboard,” “outboard” and “below” used herein are merely for ease of description and refer to the orientation of the components as shown in the figures. It should be understood that any orientation of the components described herein is within the scope of the present invention.

In a preferred embodiment of the present invention, functionality is implemented as software executing on a server that is in connection, via a network, with other portions of the system, including databases and external services. The server comprises a computer device capable of receiving input commands, processing data, and outputting the results for the user. Preferably, the server consists of RAM (memory), hard disk, network, central processing unit (CPU). It will be understood and appreciated by those of skill in the art that the server could be replaced with, or augmented by, any number of other computer device types or processing units, including but not limited to a desktop computer, laptop computer, mobile or tablet device, or the like. Similarly, the hard disk could be replaced with any number of computer storage devices, including flash drives, removable media storage devices (CDs, DVDs, etc.), or the like.

The network can consist of any network type, including but not limited to a local area network (LAN), wide area network (WAN), and/or the internet. The server can consist of any computing device or combination thereof, including but not limited to the computing devices described herein, such as a desktop computer, laptop computer, mobile or tablet device, as well as storage devices that may be connected to the network, such as hard drives, flash drives, removable media storage devices, or the like.

The storage devices (e.g., hard disk, another server, a NAS, or other devices known to persons of ordinary skill in the art), are intended to be nonvolatile, computer readable storage media to provide storage of computer-executable instructions, data structures, program modules, and other data for the mobile app, which are executed by CPU/processor (or the corresponding processor of such other components). There may be various components of the present invention that are stored or recorded on a hard disk or other like storage devices described above, which may be accessed and utilized by a web browser, mobile app, the server (over the network), or any of the peripheral devices described herein. One or more of the modules or steps of the present invention also may be stored or recorded on the server, and transmitted over the network, to be accessed and utilized by a web browser, a mobile app, or any other computing device that may be connected to one or more of the web browsers, mobile app, the network, and/or the server.

References to a “database” or to “database table” are intended to encompass any system for storing data and any data structures therein, including relational database management systems and any tables therein, non-relational database management systems, document-oriented databases, NoSQL databases, or any other system for storing data.

Software and web or internet implementations of the present invention could be accomplished with standard programming techniques with logic to accomplish the various steps of the present invention described herein. It should also be noted that the terms “component,” “module,” or “step,” as may be used herein, are intended to encompass implementations using one or more lines of software code, macro instructions, hardware implementations, and/or equipment for receiving manual inputs, as will be well understood and appreciated by those of ordinary skill in the art. Such software code, modules, or elements may be implemented with any programming or scripting language such as C, C++, C #, Java, Cobol, assembler, PERL, Python, PHP, or the like, or macros using Excel or other similar or related applications with various algorithms being implemented with any combination of data structures, objects, processes, routines or other programming elements.

What is claimed is:

1. A productivity facilitating system including:
a mixed reality device including at least one wearable technology device;
a storage medium including at least one datum of task execution instruction data,
wherein the at least one storage medium is communicatively coupled to the mixed reality device;
the at least one datum of task execution instruction including one or more coded algorithms;
at least one processor configured to:
receive the at least one datum of task execution instruction data;
interpret the at least one datum of task execution instruction data;
present the at least one datum of task execution instruction data to a user via a user interface;
one or more sensors that detect movements of one or more portions of the body and one or more sounds emitted from the user, wherein the one or more sensors are communicatively coupled to the processor to facilitate interactions between the user and the user interface;
the interactions between the user and the user interface are displayed by the mixed reality device in substantially real time, wherein the at least one datum of task execution instruction includes one or more types of training to assist the user with performing one or more tasks.

2. The system of claim 1, further including a visual capture device that is configured to transmit a portion of an environment within a field of view, wherein the user interface is communicatively coupled to the visual capture device to incorporate the environment into the at least one datum of task execution instruction data.

3. The system of claim 1, wherein the at least one datum of task execution instruction data includes the environment captured by the visual capture device, wherein the interactions between the user and the user interface incorporate and adapt to the information received by the visual capture device.

4. The system of claim 1, wherein the at least one wearable technology device includes a headgear or a headset with at least one partially transparent eye panel, wherein the at least one partially transparent eye panel is configured to present the user interface within a field of view of the user.

5. The system of claim 1, wherein the user interface includes one or more two-dimensional or three-dimensional static, moving, or movable images.

6. The system of claim 1, wherein data received by the processor from the one or more sensors is interpreted and converted to one or more instructions that facilitate one or more interactions between the user and the user interface.

7. The system of claim 1, wherein the one or more sensors include a microphone that sends and receives one or more verbal commands from the user to manipulate one or more aspects of the user interface.

8. The system of claim 1, wherein the one or more sensors include one or more motion sensors, wherein the one or more motion sensors detect one or more hand or eye movements to manipulate one or more aspects of the images of the user interface.

9. The system of claim 1, wherein the user is a sterile processing technician, wherein the productivity facilitating system trains the sterile processing technician.

10. The system of claim 9, wherein the mixed reality device provides a three-dimensional rendering of a tool that is manipulated through one or more motions, wherein the one or more motions provides information as to whether the tool is correct for a predefined operation.

11. The system of claim 9, wherein the mixed reality device includes instructional videos via the user interface for a variety of role-specific tasks.

12. The system of claim 1, wherein the productivity facilitating system includes a plurality of users.

13. The system of claim 12, wherein a first user interacts with a second user, wherein the first user transmits at least a portion of the environment within the field of view of the mixed reality device of the first user to the mixed reality device of the second user such that the second user views and interacts with the user interface of the first user.

14. The system of claim 12, wherein a first user with a mixed reality device interacts with a second user, wherein the second user utilizes a computing device to view one or more images captured by the mixed reality device of the first user.

15. A method for a productivity facilitating including:
displaying a user interface on a mixed reality device;
sending at least one datum of task execution to the user, wherein the at least one datum of task execution instruction includes one or more types of training;
sensing movement and audio of a user interacting with the mixed reality device;
capturing the environment of the user through a video capture device, wherein the sensed movement and audio of the user as well as the rendering of the captured environment is manipulated by one or more aspects of the user interface;

16. The method of claim 15, wherein the mixed reality device provides a three-dimensional rendering of a tool that is manipulated through one or more motions, wherein the one or more motions provides information as to whether the tool is correct for a predefined operation.

17. The method of claim 15, wherein the one or more types of training is to assist a sterile processing technician.

18. The method of claim 15, wherein the user interface receives the at least one datum of task execution, wherein the at least one datum of task execution includes audio and visual data.

19. The method of claim 18, wherein the audio and visual data is displayed on at least one wearable technology device with at least one partially transparent eye panel, wherein the at least one partially transparent eye panel is configured to present the user interface within a field of view of the user.

20. The method of claim 15, wherein the user interface includes one or more two-dimensional or three-dimensional static, moving, or movable images.
